(19) United States
(12) Patent Application Publication
(10) Pub. No.: US 2025/0097639 A1
(43) Pub. Date: Mar. 20, 2025

(54) Low Frequency Sound Reproduction

(71) Applicant: Nokia Technologies Oy, Espoo (FI)

(72) Inventors: Arvi Lintervo, Helsinki (FI); Mikko-Ville Laitinen, Espoo (FI); Sampo Vesa, Helsinki (FI)

(21) Appl. No.: 18/885,844

(22) Filed: Sep. 16, 2024

(30) Foreign Application Priority Data
Sep. 19, 2023 (GB) 2314341.5

(51) Int. Cl. H04R 3/04; H04S 1/00

(52) U.S. Cl. CPC H04R 3/04; H04S 1/007; H04R 2430/03

(57) ABSTRACT

Examples of the disclosure relate to reducing phase mismatches in low frequency sound reproduction. At least one low frequency component and at least one high frequency component of at least one audio signal are obtained. The at least one low frequency component is processed to generate at least one harmonic component associated with the at least one low frequency component. The harmonic components and/or the high frequency component can be adjusted relative to each other. An output signal can then be generated based on the adjusted harmonic component and high frequency component. The output signal is generated to have improved low frequency perception during playback.

### TECHNOLOGICAL FIELD

Examples of the disclosure relate to low frequency sound reproduction. Some relate to reducing phase mismatches in low frequency sound reproduction.

### BACKGROUND

Low frequency sound reproduction, for example, virtual bass reproduction, can be used to enable a perception of low frequency sound in devices that are not capable of low frequency reproduction. Such devices could be small devices such as mobile phones.

### BRIEF SUMMARY

According to various, but not necessarily all, examples of the disclosure, there is provided an apparatus comprising means for:
obtaining at least one audio signal;
obtaining at least one low frequency component and at least one high frequency component of the at least one audio signal;
processing the at least one low frequency component to generate at least one harmonic component associated with the at least one low frequency component; adjusting at least one of the at least one harmonic component and the at least one high frequency component relative to each other; and
generating an output signal based on the adjusted at least one harmonic component and at least one high frequency component to cause improved low frequency perception of the at least one audio signal during playback.

The means may be for determining a synchrony value based, at least on, the high frequency component and the generated at least one harmonic component and wherein the adjustment of at least one of the at least one harmonic component and the at least one high frequency component relative to each other controls synchrony between the at least one high frequency component and the at least one harmonic component.

Determining a synchrony value may comprise determining a level of coherence between the at least one harmonic component associated with the at least one low frequency component and the at least one high frequency component for different delay adjustments between the two components.

Synchrony values may be determined for different frequency bands and the adjustments may be made separately for different frequency bands.

The means may be for filtering the at least one harmonic component associated before the synchrony value is determined.

The means may be for adding a delay to the high frequency component before the synchrony value is determined.

The adjustment may comprise adjusting the delay added to the high frequency component.

Generating an output signal based on the adjusted at least one harmonic component and at least one high frequency component may comprise summing the at least one high frequency component and the adjusted at least one harmonic component to produce the output signal.

The processing of the at least one low frequency component to generate the at least one harmonic component associated with the at least one low frequency component may comprise applying a nonlinear function to the low frequency component.

The adjustment may comprise adjusting a phase of at least one of the high frequency components or the at least one harmonic component.

The audio signal may comprise multiple channels.

The at least one low frequency component may be obtained for a sum of two or more channels of the audio signal.

The at least one high frequency component may be obtained for a subset of channels of the audio signal.

According to various, but not necessarily all, examples of the disclosure, there is provided a method comprising:
obtaining at least one audio signal;
obtaining at least one low frequency component and at least one high frequency component of the at least one audio signal;
processing the at least one low frequency component to generate at least one harmonic component associated with the at least one low frequency component; adjusting at least one of the at least one harmonic component and the at least one high frequency component relative to each other; and
generating an output signal based on the adjusted at least one harmonic component and at least one high frequency component to cause improved low frequency perception of the at least one audio signal during playback.

According to various, but not necessarily all, examples of the disclosure, there is provided a computer program comprising instructions which, when executed by an apparatus, cause the apparatus to perform at least:
obtaining at least one audio signal;
obtaining at least one low frequency component and at least one high frequency component of the at least one audio signal;
processing the at least one low frequency component to generate at least one harmonic component associated with the at least one low frequency component; adjusting at least one of the at least one harmonic component and the at least one high frequency component relative to each other; and
generating an output signal based on the adjusted at least one harmonic component and at least one high frequency component to cause improved low frequency perception of the at least one audio signal during playback.

While the above examples of the disclosure and optional features are described separately, it is to be understood that their provision in all possible combinations and permutations is contained within the disclosure. It is to be understood that various examples of the disclosure can comprise any or all of the features described in respect of other examples of the disclosure, and vice versa. Also, it is to be appreciated that any one or more or all of the features, in any combination, may be implemented by/comprised in/performable by an apparatus, a method, and/or computer program instructions as desired, and as appropriate.

### BRIEF DESCRIPTION

Some examples will now be described with reference to the accompanying drawings in which:

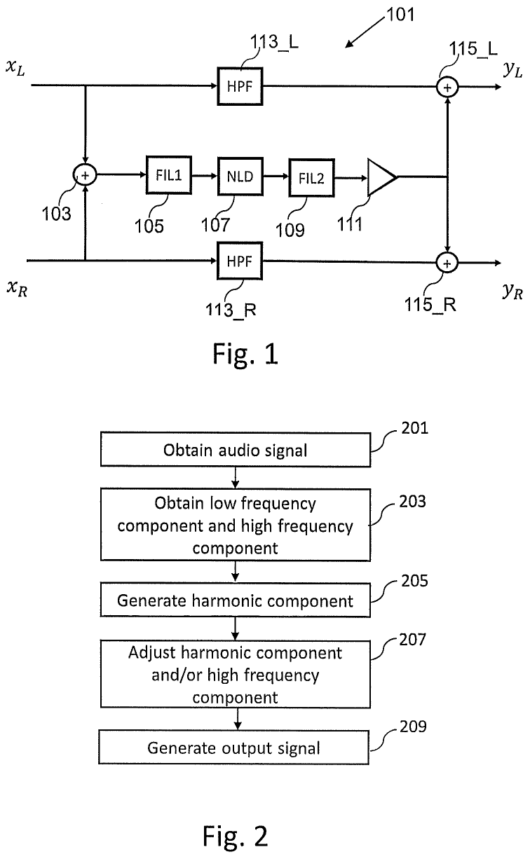

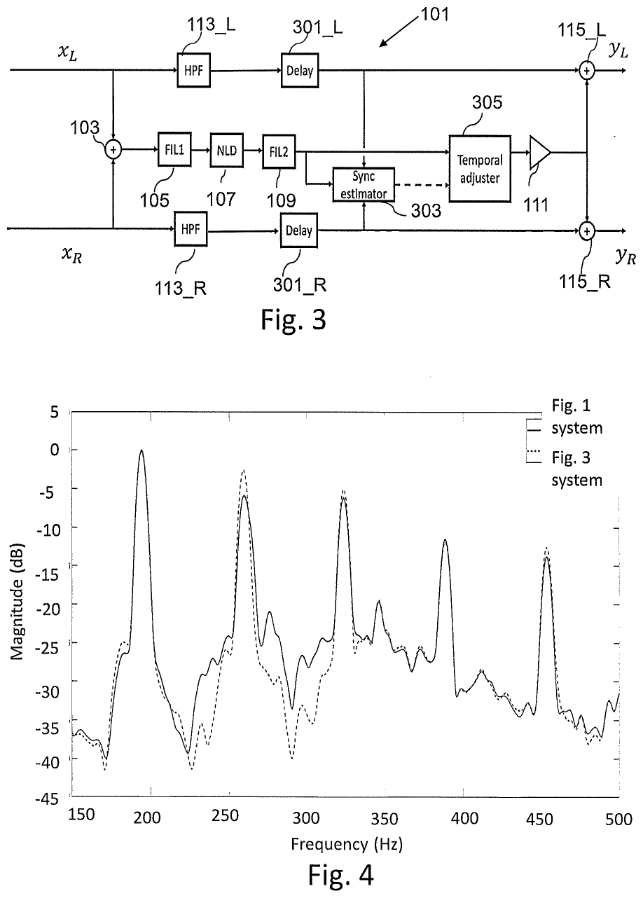

FIG. 1 shows a virtual bass system;

FIG. 2 shows a method;

FIG. 3 shows a virtual bass system;

FIG. 4 shows an output; and

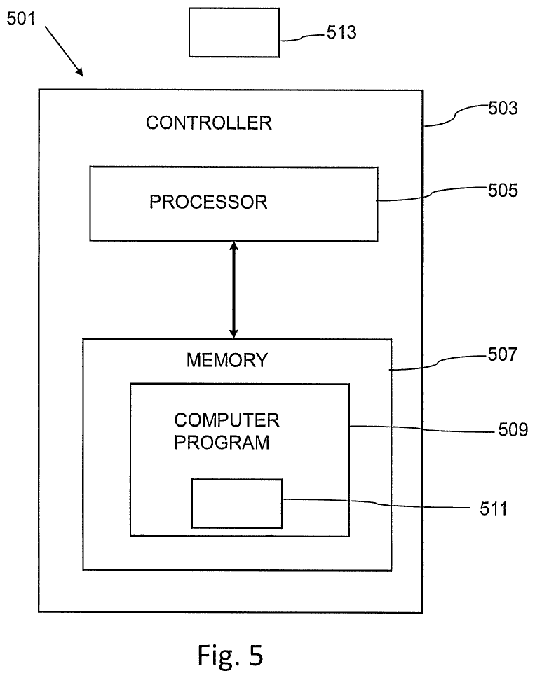

FIG. 5 shows an example apparatus.

The figures are not necessarily to scale. Certain features and views of the figures can be shown schematically or exaggerated in scale in the interest of clarity and conciseness. For example, the dimensions of some elements in the figures can be exaggerated relative to other elements to aid explication. Corresponding reference numerals are used in the figures to designate corresponding features. For clarity, all reference numerals are not necessarily displayed in all figures.

### DETAILED DESCRIPTION

FIG. 1 shows a virtual bass system 101 that can be used to enable a perception of bass in a device that is not capable of low frequency reproduction. The device could be a small device such as a mobile phone or any other suitable type of device.

The virtual bass system 101 is configured to reproduce harmonic components related to missing low-frequency components. The virtual bass system 101 can generate a psychoacoustic bass enhancement signal. This creates a perception of bass being reproduced even though the low frequencies are not physically reproduced. The perception of the lower bass, that is not physically present, is due to the missing fundamental phenomena. The missing fundamental phenomena is a situation, where a human perceives series of harmonic frequency components of complex tones as a pitch related to the frequency spacing of the harmonics, even though the fundamental frequency is not present.

The virtual bass system 101 receives a right channel signal x_{R} and a left channel signal x_{L}. The respective channel signals x_{R}, x_{L} are summed by a sum block 103 and then filtered using a filter 105. The filter 105 can be bandpass filter and/or a lowpass filter. The filter 105 is configured to separate out the low frequency components. The filter 105 is configured to separate out the parts of the signal from which the harmonics can be created. The filter 105 can have any suitable range such as 20-150 Hz.

The filter 105 provides a filtered mono signal as an output. The virtual bass system 101 is configured so that the filtered mono signal is provided as an input to a non-linear function block 107. The non-linear function block 107 generates the harmonic frequency components.

The type of non-linear function that is used by the non-linear function block 107 will determine parameters of the generated harmonic frequencies. For instance, the type of non-linear function that is used can affect the number, spacing (odd/even/both) and magnitudes of the generated harmonic frequencies. Also, the symmetry of the nonlinear function will have an impact on the perception of the generated psychoacoustic bass enhancement signal.

The non-linear function can be homogeneous or non-homogeneous. If the non-linear function is homogeneous then the amplitude of input signal doesn't impact on the generated harmonic frequency content. If the non-linear function is non-homogeneous then the generated harmonic frequencies depend on the level of the input signal.

The output of the non-linear function block 107 is provided as an input to another filter 109. The filter 109 can be a bandpass filter or any other suitable type of filter. The filter 109 is configured to filter out the unwanted parts of the output of the non-linear function block 107. The filter 109 provides a harmonics signal as an output.

In the example of FIG. 1 a gain block 111 is configured to apply a gain to the harmonics signal to adjust the level of the harmonic signal.

The virtual bass system 101 is also configured so that the right channel signal x_{R} is filtered by a high pass filter 113_R and the left channel signal x_{L} is also filtered by a high pass filter 113_L.

The harmonics signal can be added to the high pass filtered right signal by a sum block 115_R to provide a right channel output y_{R} and the harmonics signal can be added to the high pass filtered left signal by a sum block 115_L to provide a left channel output y_{L}.

In the example virtual bass system 101 of FIG. 1 when the harmonics signal is summed with the high pass filtered signals there can be a phase mismatch in the harmonics between the generated harmonics signal and the high-pass filtered original signals. The phase mismatch can be time varying. The phase mismatch can be frequency dependent.

The phase mismatch results in the output signals having less bass than they would if the phases were matched. This is caused by the destructive interference of the non-phase aligned signals. In addition, there may be intermodulation components present in the generated harmonics signal. The intermodulation components can degrade the signal quality. If the desired components get cancelled out to some extent due to the phase mismatch, then the undesired intermodulation components can sound louder than they should be. This can cause a perception of audible distortion.

Examples of the disclosure are configured to improve the generation of virtual bass by aligning the generated harmonic components more accurately with the rest of the signal. This will create a perception of louder bass.

FIG. 2 shows an example method that can be used to align the generated harmonic components more accurately with the rest of the signal in some examples of the disclosure.

At block 201 the method comprises obtaining at least one audio signal. The audio signal can comprise multiple channels. For example, the audio signal can comprise a right channel and a left channel or any other suitable arrangement of channels.

At block 203 the method comprises obtaining at least one low frequency component and at least one high frequency component of the at least one audio signal. The low frequency component can comprise the bass signal. The low frequency component can comprise frequencies that are too low to be reproduced by a playback device and the high frequency component can comprise frequencies that can be reproduced by the playback device.

In examples where the audio signal comprises multiple channels then the low frequency component can be obtained for a sum of two or more channels of the audio signal. The high frequency component can be obtained for a subset of channels of the audio signal or can be obtained for all of channels of the audio signal.

At block 205 the method comprises processing the at least one low frequency component to generate at least one harmonic component associated with the at least one low frequency component. The harmonic component is associated with the at least one low frequency component in that it is obtained by processing the low frequency component.

The processing of the at least one low frequency component to generate the at least one harmonic component associated can comprise applying a nonlinear function to the low frequency component and/or any other suitable processing.

At block 207 the method comprises adjusting at least one of the harmonic components and the high frequency component relative to each other.

The adjustment can comprise a temporal adjustment. The adjustment can bring the harmonic components closer into alignment with the high frequency components. In some examples the adjustment can comprise adding a delay to at least one of the of the harmonic components and the high frequency component. In some examples the adjustment can comprise adjusting a phase of at least one of the harmonic components and the high frequency component.

In some examples different adjustments can be made for different frequency bands. The different adjustments could be different temporal adjustments. The different adjustments for different frequency bands can take into account different levels of synchrony for the different frequency bands.

At block 209 the method comprises generating an output signal based on the adjusted at least one harmonic component and at least one high frequency component to cause improved low frequency perception of the at least one audio signal during playback.

In some examples the output signal can be generated by summing the at least one high frequency component and the adjusted at least one harmonic component. The summing produces an output signal. The output signal is a psychoacoustic bass enhancement signal because the harmonic components create a perception of bass being reproduced even though the low frequencies are not physically reproduced or the level of them is very low. In this output signal the perception of the bass is improved because the phase mismatch in the harmonics between the generated harmonics signal and the high-pass filtered original signals is reduced.

In some examples the method can comprise additional blocks that are not shown in FIG. 2. In some examples the method can comprise determining a synchrony value.

The synchrony value can be determined based, at least on, the high frequency component and the generated at least one harmonic component. The adjustment of at least one of the harmonic components and the at least one high frequency component relative to each other controls synchrony between the harmonic component and the high frequency component.

The synchrony value can provide an indication of any phase mismatches between harmonics in the harmonic component and harmonics in the high frequency component. The synchrony value can provide an indication of the magnitude of any such phase mismatches.

In some examples determining a synchrony value can comprise determining a level of coherence between the at least one harmonic component and the at least one high frequency component for different delay adjustments between the two components. The synchrony value can then be associated with the adjustment that produces a determined level of coherence. The level of coherence that is determined can be the highest level of coherence, a level above a threshold or any other suitable level.

In some examples the synchrony value can be determined different frequency bands. In such examples different frequency bands can have different synchrony values. In such examples the adjustments can be made separately for different frequency bands so as to account for the different synchrony values. This can enable different adjustments to be made for different frequency bands.

In some examples the at least one harmonic component associated with the at least one low frequency component can be filtered before the synchrony value is determined. The filtering can be a high pass filter or a low pass filter.

In some examples a delay can be added to the to the high frequency component before the synchrony value is determined. The delay could be added by a delay block and/or by processing of the high frequency component.

In some examples other types of processing, such as compression, could be performed on the harmonic component and/or the high frequency component before the synchrony value is determined.

In examples where a delay is added to the high frequency component before the synchrony value is determined then the adjustment can be made by adjusting the delay that is added to the high frequency component.

FIG. 3 shows a virtual bass system 101 that is configured to align a generated virtual bass signal more accurately with the rest of the signal.

The virtual bass system 101 is configured to obtain at least one audio signal. In this example the obtained audio signals are stereo signals. The stereo signals comprise a right channel signal x_{R}(t) and a left channel signal x_{L}(t). In this example (t) indicates the sample index. Other types of input signals can be obtained in other examples.

The virtual bass system 101 is also configured so that the right channel signal x_{R} is filtered by a high pass filter 113_R and the left channel signal x_{L} is also filtered by a high pass filter 113_L.

The respective high pass filters 113_R, 113_L can be any suitable type of filters. In some examples the high pass filters 113_R, 113_L can be a 4th order Infinite Impulse Response (IIR) filter with the cut-off frequency at 200 Hz. Other types of filters and values for the cut-off frequency can be used in other examples.

The high pass filters 113_R, 113_L provide high pass signals x_{R,HP}(t) and x_{L,HP}(t) as outputs. The high pass signals x_{R},HP (t) and x_{L,HP}(t) are forwarded to delay blocks 301_R, 301_L. The delay blocks 301_R, 301_L are configured to delay the high pass signals x_{R,HP}(t) and x_{L,HP}(t).

The amount of delay that is added by the delay blocks 301_R, 301_L can be constant. The amount of delay that is added by the delay blocks 301_R, 301_L can correspond to an interval that the adjustment of the generated harmonics signal is operating within.

This interval can be tuned depending on the delay requirements of the virtual bass system 101.

The delay blocks 301_R, 301_L provide Delayed high-pass signals x_{R,HP,D}(t) and x_{L,HP,D}(t) as an output.

The virtual bass system 101 is also configured so that the input right channel signal x_{R} and the input the left channel signal x_{L} are forwarded to a sum block 103. The sum block 103 sums the input right channel signal x_{R} and the input the left channel signal x_{L} to generate a sum signal x_{S}(t)=x_{L}(t)+x_{R}(t).

The sum signal is forwarded to a filter 105. The filter 105 can be bandpass filter, a low pass filter, or a cascade of a bandpass filter and a lowpass filter. The filter 105 can be configured to perform low-pass filtering of the sum signal. The filter 105 can be used for removing DC (direct current) components from the sum signal.

This filter 105 can be a 4th order IIR filter. The filter 105 can have any suitable cut-off frequencies. For example, the upper cut-off frequency could be at 200 Hz. If the filter 105 is a bandpass filter a lower cut-off frequency could be at 20 Hz.

Other values for the cut-off frequencies can be used in other examples. The value of the cut-off frequencies can be decided based on the output performance of the device and/or any other suitable factor.

In the example of FIG. 3 one filter 105 is shown. In some examples the filter 105 could comprise a cascade of multiple filters. At least one of the filters in the cascade could be a high-pass filter that is configured to remove a DC component and at least one of the filters in the cascade could be low-pass filter. The high pass filter could have a cut-off frequency at 20 Hz and the low-pass filter could have a cut-off at 200 Hz. Other cut-off frequencies could be used for the filters in other examples.

The filter 105 provides a low-pass sum signal x_{S,LP}(t) as an output. The low-pass sum signal x_{S,LP}(t) is forwarded to a non-linear function block 107. The non-linear function block 107 is configured to apply non-linearity to the low-pass sum signal x_{S,LP}(t). There are multiple different ways in which the application of the non-linearity can be realized.

In some examples, the non-linearity can be applied by feeding the low-pass sum signal x_{S,LP}(t) to the following function

$${x}_{NL} ( t ) = \frac{e - {e}^{1 - {x}_{S , LP} ( t )}}{e - 1}$$

The non-linear function block 107 provides a non-linearized signal x_{NL}(t) as an output. The non-linearized signal x_{NL}(t) contains harmonics of the bass frequencies because the low-pass sum signal” x_{S,LP}(t) has been processed with a non-linear function.

The non-linearized signal x_{NL}(t) is provided as an input to another filter 109. The filter 109 can be a bandpass filter or any suitable type of filter. In some examples the filter 109 can comprise two cascaded 4th order IIR filters. In such cases the first IIR filter can be a low-pass filter and the second IIR filter can be a high-pass filter. The low pass filter could have a cut-off at 1000 Hz or any other suitable frequency and the high-pass filter could have a cut-off at 200 Hz or any other suitable frequency.

The low-pass filtering of the filter 109 can be performed to remove undesired distortion components at high frequencies. Such distortion components at the frequencies above the filter cut-off frequency could cause a degradation of the perceived audio quality.

The high-pass filtering of the filter 109 can be performed to remove frequencies that the device cannot reproduce. This enables the transducer to be driven at the optimal frequency range, or at substantially the optimal frequency range, and mitigates an additional distortion caused by driving the transducer at too low frequencies.

The determining of the synchrony value and the control of the synchrony is to be performed for the frequencies that the device can reproduce and for the frequencies where the generated harmonics are. The high-pass filtering of the filter 109 is therefore also performed so that the lowest frequencies are removed before the determining of the synchrony value and the control of the synchrony so that they don't skew the analysis.

The filter 109 provides a band-pass non-linearized signal x_{NL,BP}(t) as an output. The band-pass non-linearized signal x_{NL,BP}(t) is forwarded to a sync estimator block 303. The sync estimator block 303 also receives the delayed high-pass signals x_{L,HP,D}(t) and x R,HP,D (t) as an input.

The sync estimator block 303 is configured to determine a synchrony value. In this case the band-pass non-linearized signal x_{NL,BP}(t) provides a generated harmonic component and the delayed high-pass signals x_{L,HP,D}(t) and x_{R,HP,D}(t) provide the original harmonic components that were present in the input signal at the frequencies where the harmonic signals were generated. The synchrony value can provide an indication of any phase mismatches between harmonics in the harmonic component and harmonics in the high frequency component. The synchrony value can provide an indication of the magnitude of any such phase mismatches.

In the example of FIG. 3 the synchrony value can be determined by estimating the delay with which the coherence between the signals is the largest. Any suitable process or method can be used to determine this delay. As an example, the estimation could comprise calculating the correlation values R₍ₓ_{_{NL,BP}}_{),(x}_{_{S,HP,D}}₎ between the Band-pass non-linearized signal x_{NL,BP}(t) and sum signal of the Delayed high-pass signals

$${x}_{S , HP , D} ( t ) = {x}_{L , HP , D} ( t ) + {x}_{R , HP , D} ( t ) .$$

The correlation can be calculated as:

$${R}_{( {x}_{NL , BP} ) , ( {x}_{S , HP , D} )} ( f ) = \{ {x}_{NL , BP} \} \cdot {\{ {x}_{S , HP , D} \}}^{*} ,$$

Where [symbol] denotes the Fourier transformation, * denotes the complex conjugate, and ƒ is the center frequency of corresponding frequency bin.

To obtain the correlation values with different delays, the correlation values are phase shifted:

$${R}_{s , ( {x}_{NL , BP} ) , ( {x}_{S , HP , D} )} ( f , t ) = Re \{ {R}_{( {x}_{NL , BP} ) , ( {x}_{S , HP , D} )} ( f ) \cdot {e}^{2 \cdot π \cdot i \cdot f \cdot t} \}$$

where Re{ } denotes taking the real part.

The coherence value at different time delays at different frequencies can be calculated by dividing the shifted correlation values with inverse-squared multiplication of auto spectral magnitude values.

$${C}_{s , ( {x}_{NL , BP} ) , ( {x}_{S , HP , D} )} ( f , t ) = \frac{{R}_{s , ( {x}_{NL , BP} ) , ( {x}_{S , HP , D} )} ( f , t )}{\sqrt{{G}_{( {x}_{NL , BP} )} ( f ) \cdot {G}_{( {x}_{S , HP , D} )} ( f )}} ,$$

Where G₍ₓ_{_{NL,BP}}₎(ƒ) is the auto spectral density of signal x_{NL,BP} and G₍ₓ_{_{S,HP,D}}₎(ƒ) is the auto spectral density of signal x_{S,HP,D}. Auto spectral densities are calculated as follows:

$${G}_{( {x}_{NL , BP} )} ( f ) = {\vert \{ {x}_{NL , BP} \} \vert}^{2} ,$$

$${G}_{( {x}_{S , HP , D} )} ( f ) = {\vert \{ {x}_{{x}_{S , HP , D}} \} \vert}^{2} .$$

The optimal delay values at different frequencies can be obtained by finding the delay value corresponding the maximum coherence value:

$${t}_{sync} ( f ) = max ( {C}_{s , ( {x}_{NL , BP} ) , ( {x}_{S , HP , D} )} ( f , t ) ) ,$$

where max( ) function finds the maximum coherence value, and outputs corresponding time index. In this example the maximum coherence value can be a synchrony value. Other type of synchrony values could be used in other examples.

The synchrony value can be used to determine an adjustment that is to be applied to one or more of the signals within the virtual bass system 101. In the example of FIG. 3 the adjustment is a temporal adjustment and the virtual bass system 101 comprises a temporal adjuster block 305 that is configured to apply the temporal adjustment to the band-pass non-linearized signal x_{NL,BP}(t). In other examples the virtual bass system 101 can be configured to apply a temporal adjustment to the high frequency component. The temporal adjustment to the high frequency component can be added instead of, or in addition to, a temporal adjustment applied to the harmonic components.

Also, in this example the temporal adjustment comprises a delay. In some examples the band-pass non-linearized signal x_{NL,BP}(t) and/or the high frequency component could be advanced by a suitable amount.

It is not important which of the signals is delayed or advanced. It is important that the difference between the harmonic components and the high frequency components is compensated for. This compensation can be performed by delaying/advancing one or both of the signals. Similarly, phase compensation could be performed for any of the components, or both of the components.

The synchrony value can be used to determine a value for the adjustment. In this example this could be a t_{sync} value at which frequency highest coherence is attained.

In examples of the disclosure the synchrony values can be determined for wider frequency bands, or over the whole frequency range, by summing suitable frequency bins of the calculated correlation and auto spectral density values. For example, a typical bandwidth where the coherence analysis would be performed, could be from 200 Hz to 1 kHz, because the generated harmonic distortion will be at this frequency range.

The sync estimator block 303 provides the value of the adjustment t_{sync} as an output. The value of the adjustment t_{sync} and the band-pass non-linearized signal x_{NL,BP}(t) are forwarded to the temporal adjuster block 305. The temporal adjuster block 305 is configured to adjust the band-pass non-linearized signal x_{NL,BP}(t) by delaying it by t_{sync} samples. For example;

$${x}_{NL , BP , TA} ( t ) = {x}_{NL , BP} ( t - {t}_{sync} )$$

In some examples the virtual bass system 101 can be configured to mitigate discontinuity of the adjusted band-pass non-linearized signal x_{NL,BP}(t). For example, the adjustment t_{sync} values can be smoothed with a low-pass filter, or any other suitable means, before they are applied on the respective signals.

In some examples the smoothing could be performed adaptively based on the signal energy value for the low frequency content. For example, when the signal energy at low frequencies exceeds a certain threshold, the adjustment t_{sync} values can be adjusted more aggressively. In some examples, only adjustment t_{sync} values of frames where the energy is high enough might be applied.

The temporal adjuster block 305 provides an adjusted non-linearized signal x_{NL,BP,TA}(t) as an output. The adjusted non-linearized signal x_{NL,BP,TA}(t) can be provided to a gain block 111. The gain block 111 is configured to apply a gain to the adjusted non-linearized signal x_{NL,BP,TA}(t), for example:

$${x}_{NL , BP , TA , G} ( t ) = g {x}_{NL , BP , TA} ( t )$$

where g is a gain.

Then, finally, the gained adjusted non-linearized signal x_{NL,BP,TA,G}(t) can be combined with the delayed high-pass signals by the sum blocks 115_R, 115_L to provide output signals:

$${y}_{L} ( t ) = {x}_{NL , BP , TA , G} ( t ) + {x}_{L , HP , D} ( t )$$

$${y}_{R} ( t ) = {x}_{NL , BP , TA , G} ( t ) + {x}_{R , HP , D} ( t )$$

In this example the gain applied by the gain block 111 is a fixed gain. In other examples the gain applied by the gain block 111 could vary over time. For example, the level of the adjusted non-linearized signal x_{NL,BP,TA,G}(t) could be compared to the level of the low-pass sum signal x_{S,LP}(t) it was generated from. A time-varying gain could then be applied to match the level of the adjusted non-linearized signal x_{NL,BP,TA,G}(t) to that of the original low-pass sum signal x_{S,LP}(t).

The output signals y_{R}(t) and y_{L}(t) can then be reproduced for playback to a listener.

The output signals y_{R}(t) and y_{L}(t) of the virtual bass system 101 have improved alignment between the generated virtual bass signal and the high frequency components. This provides for improved quality of the output signals.

FIG. 4 shows outputs that can be obtained with examples of the disclosure. In the plot of FIG. 4 the solid line represents an output obtained with a virtual bass system 101 as shown in FIG. 1 in which the harmonic components are not adjusted. The dashed line represents an output obtained with a virtual bass system 101 as shown in FIG. 3 in which the harmonic component is adjusted.

The input signal that was processed to obtain the outputs shown in FIG. 4 was an excerpt of a traditional pop song comprising a deep bass, drums, synth, and vocals.

The plot in FIG. 4 shows that using examples of the disclosure to process the input signals increases the energy of the desired harmonic frequency components (˜195 Hz, ˜260 Hz, ˜325 Hz, ˜390 Hz, ˜455 Hz) while the energy between these frequency components is decreased. The increased energy of the harmonic frequency components will increase the amount of perceived bass. In addition to the increased amount of bass, the perceived audio quality will improve as the energy of the undesired frequencies between the desired frequency components is decreased.

Table 1 indicates the magnitude differences between the harmonic frequency components of the processing using the system of FIG. 1 and the harmonic frequency components of the processing using the system of FIG. 3. The magnitude differences of the peaks were calculated over slightly wider (+/−5 Hz) frequency range.

The example processing of the system of FIG. 3 estimates the synchrony value and the adjustment for the frequencies above 200 Hz. Therefore, the magnitudes of the harmonic frequency components above 200 Hz are increased.

The estimated delay might not be optimal for all the frequency components. Therefore, some magnitudes might decrease. However, the overall performance increases through the use of a virtual bass system 101 such as the system of FIG. 3. This can be seen from the magnitude of the frequency component at 390 Hz. This frequency component is slightly decreased using the system of FIG. 3. However, as the magnitudes of the other frequency components above the 200 Hz are increased, the overall perceived bass will be increased.

TABLE 1

| Frequencies of desired | Gain increase or reduction with |
|---|---|
| harmonic components | presented invention |
| 195 Hz | −0.2 dB |
| 260 Hz | +2.6 dB |
| 325 Hz | +1.1 dB |
| 390 Hz | −0.3 dB |
| 455 Hz | +1.2 dB |

Table 2 shows the magnitude differences of undesired frequency content. This table shows the mean and maximum magnitude differences of the frequency regions comprising undesired frequency content between processing using the system of FIG. 1 and processing using the system of FIG. 3. On average, the system of FIG. 3 reduces the energy from the undesired frequency range between the desired frequency components. As an example, the average reduction of the undesired frequency content at frequencies between 260 Hz and 325 Hz is-5.9 dB and the maximum reduction is-8.6 dB. This reduction will lead to an improved audio quality. Furthermore, at higher frequency regions (between 335-380 Hz and 400-445 Hz) the average increment (+0.1 dB) of energy is neglectable.

TABLE 2

| Frequency ranges of undesired | Gain increase or reduction with |
|---|---|
| content between harmonics | presented invention |
| 205-250 Hz | Mean: −2.7 dB, Max: −9.7 dB |
| 270-315 Hz | Mean: −5.9 dB, Max: −8.6 dB |
| 335-380 Hz | Mean: +0.1 dB, Max: −1.8 dB |
| 400-445 Hz | Mean: +0.1 dB, Max: −0.5 dB |

Variations to the virtual bass system 101 of FIG. 3 can be used in some examples of the disclosure. For instance, in FIG. 3 the input signal comprised stereo signals. In other examples, the input signals can be some other format. For example, the input signals could comprise mono signals, multi-channel signals (such as, 5.1 or 7.1+4), or signals in any other format. The input signals can be summed together before they are fed to the non-linear function block 107 so the number and/or the format of the input signals does not necessarily affect the method. In some examples the system 101 can be configured so that the input channels can be processed separately. In such examples, different processing paths could be used for different channels or different subsets of channels.

In the above-described examples, the adjustment that was applied was a delay. In other examples the adjustment could comprise an adjustment of the phase. For example, the input signals could be processed with short-time Fourier transform (STFT). The optimal phase could be estimated for the STFT bins. The optimal phase can be estimated using any suitable process. In some examples the optimal phase can be estimated by finding the phase with which the largest coherence is obtained when computing the coherence between the harmonic components and the high-pass filtered signals. Then, the phases of the harmonic components can be adjusted in the STFT domain based on this computed coherence. The resulting signal can be transformed back to the time domain and summed with the high-pass filtered signals.

The example of FIG. 3 only shows a single synchrony value being determined and a single adjustment being applied. In the example of FIG. 3 the adjustment was performed broadband in the time domain. In other examples, the synchrony value and a value for the adjustment could be estimated in frequency bands. This could be achieved by computing the coherence value using only the bins inside the corresponding frequency bands. Then, the delay could be adjusted separately for different frequency bands. The delay could be adjusted by using a filter bank for obtaining the signals for the different frequency bands and delaying those signals, or by adjusting the phases of the corresponding frequency bins in the STFT domain.

In the above-described examples, some example values for the cut-off frequencies and the filter orders are given. These are merely example values, and different values may be used in different examples of the disclosure. Similarly, different filter types can be used in different examples of the disclosure. For instance, in the example of FIG. 3 the filter 105 that is used to filter the sum signal x_{S}(t) and provide a low-pass sum signal x_{S,LP}(t) as an output is described as a low-pass filter with a cut-off at 200 Hz. Different examples can use different values. The cut-off frequency can be selected based on which frequencies the driver cannot properly reproduce. If the driver can properly reproduce lower frequencies than 200 Hz, this cut-off frequency may be lowered. Conversely, if the driver cannot reproduce even the frequencies above 200 Hz, the cut-off frequency may be increased. However, virtual bass phenomenon does not work with arbitrarily high frequencies, due to the features of the human hearing, so the cut-off frequency rarely is higher than about 500 Hz.

Also, in the above-described examples the filter 109 that receives the non-linearized signal x_{NL}(t) as an input and provides a band-pass non-linearized signal x_{NL,BP}(t) as an output was limited to the band of, 200-1000 Hz in the example embodiment. This range also depends on the implementation and the driver capabilities. There is no absolute lower frequency limit for the range which should be used. However, making harmonics for frequencies that the driver cannot properly reproduce does not improve the quality. Similarly, there is no absolute higher limit for the harmonics. However, the harmonics above, 1000-2000 Hz do not typically improve the perception of virtual bass. These harmonics are perceived as distortion. The non-linearity used by the non-linear function block 107 affects this cut-off frequency. Some non-linearities may produce the harmonics above 1000-2000 Hz with such a low level that there is no need for the low-pass filter after the non-linear function block 107.

In the example of FIG. 3 the high pass signals x_{R,HP}(t) and x_{L,HP}(t) are delayed by the delay blocks 301_R, 301_L. The amount of delay added by the delay blocks 301_R, 301_L corresponds to the maximum value of the adjustments that can be added by the temporal adjuster block 305. This enables the adjustment to be performed in real-time processing (it is not possible to advance signals in real-time processing).

In some examples, there could be additional processing blocks in the overall processing path that cause delay. For example, a stereo widening method or any other suitable methods, could be used, which may cause some delay. If the delay added by the additional processing blocks is larger than the delay added by the delay blocks 301_R, 301_L then the delay blocks 301_R, 301_L can be omitted and replaced by the additional processing block. In such examples the temporal adjuster block 305 can be configured to adjust the band-pass non-linearized signal x_{NL,BP}(t) so that it matches the processed high-pass filtered signal. If the delay added by the additional processing blocks is smaller than the delay added by the delay blocks 301_R, 301_L then the additional processing block and the delay blocks 301_R, 301_L can be cascaded. The delay caused by the additional processing can be subtracted from the delay that is applied by the delay blocks 301_R, 301_L.

In some examples the delay blocks 301_R, 301_L can be configured so that the delay applied is fixed. In some examples the delay blocks 301_R, 301_L can be configured to be adaptively tuned. The adaptive tuning can be used to find the maximum delay added by the temporal adjuster block 305. For example, if the temporal adjuster block 305 applies short delays on average for some interval, then the delay applied by the delay blocks 301_R, 301_L can be made shorter. Conversely if the temporal adjuster block 305 applies long delays on average for some interval, then the delay applied by the delay blocks 301_R, 301_L can be made longer.

The temporal adjuster block 305 can be configured to adjust the band-pass non-linearized signal x_{NL,BP}(t) by any suitable amount. In some examples the adjustment can comprise integer values for t_{sync}. In other examples t_{sync} does not need to be an integer. This could allow for the adjustment applied by the temporal adjuster block 305 to take fractional values. This can enable the amount of delay added to the respective signals to be changed seamlessly.

In some examples the synchrony value and/or the adjustment to be applied can be estimated for each frame. In other embodiments, the synchrony value and/or the adjustment to be applied can be computed more sparsely. For example, the synchrony value could be computed for only every second frame or every third frame or for other sequences of frames. If a synchrony value and/or the adjustment to be applied are not estimated for a frame, then the values of the previous frame for which they were estimated can be used for the frames instead. This can decrease the computational complexity.

In examples where a transform such as a Fast Fourier Transform (FFT) is used any suitable windows can be applied to the signals before computing the FFT. For instance, a rectangular window or a Hahn window could be used. In some examples no window could be applied.

FIG. 5 schematically illustrates an apparatus 501 that can be used to implement examples of the disclosure. In this example the apparatus 501 comprises a controller 503. The controller 503 can be a chip or a chip-set. The apparatus 501 can be provided within a mobile phone or any other suitable type of device that might be used to generate virtual bass.

In the example of FIG. 5 the implementation of the controller 503 can be as controller circuitry. In some examples the controller 503 can be implemented in hardware alone, have certain aspects in software including firmware alone or can be a combination of hardware and software (including firmware).

As illustrated in FIG. 5 the controller 503 can be implemented using instructions that enable hardware functionality, for example, by using executable instructions of a computer program 509 in a general-purpose or special-purpose processor 505 that may be stored on a computer readable storage medium (disk, memory etc.) to be executed by such a processor 505.

The processor 505 is configured to read from and write to the memory 507. The processor 505 can also comprise an output interface via which data and/or commands are output by the processor 505 and an input interface via which data and/or commands are input to the processor 505.

The memory 507 stores a computer program 509 comprising computer program instructions (computer program code 511) that controls the operation of the controller 503 when loaded into the processor 505. The computer program instructions, of the computer program 509, provide the logic and routines that enables the controller 503. to perform the methods illustrated in the accompanying Figs. The processor 505 by reading the memory 507 is able to load and execute the computer program 509.

The apparatus 501 comprises:
at least one processor 505; and
at least one memory 507 storing instructions that, when executed by the at least one processor 505, cause the apparatus 501 at least to perform:
   obtaining 201 at least one audio signal;
   obtaining 203 at least one low frequency component and at least one high frequency component of the at least one audio signal;
   processing 205 the at least one low frequency component to generate at least one harmonic component associated with the at least one low frequency component;
   adjusting 207 at least one of the at least one harmonic component and the at least one high frequency component relative to each other; and
   generating 209 an output signal based on the adjusted at least one harmonic component and at least one high frequency component to cause improved low frequency perception of the at least one audio signal during playback.

As illustrated in FIG. 5, the computer program 509 can arrive at the controller 503 via any suitable delivery mechanism 513. The delivery mechanism 513 can be, for example, a machine readable medium, a computer-readable medium, a non-transitory computer-readable storage medium, a computer program product, a memory device, a record medium such as a Compact Disc Read-Only Memory (CD-ROM) or a Digital Versatile Disc (DVD) or a solid-state memory, an article of manufacture that comprises or tangibly embodies the computer program 509. The delivery mechanism can be a signal configured to reliably transfer the computer program 509. The controller 503 can propagate or transmit the computer program 509 as a computer data signal. In some examples the computer program 509 can be transmitted to the controller 503 using a wireless protocol such as Bluetooth, Bluetooth Low Energy, Bluetooth Smart, 6LoWPan (IPv6 over low power personal area networks) ZigBee, ANT+, near field communication (NFC), Radio frequency identification, wireless local area network (wireless LAN) or any other suitable protocol.

The computer program 509 comprises computer program instructions for causing an apparatus 501 to perform at least the following or for performing at least the following:
obtaining 201 at least one audio signal;
obtaining 203 at least one low frequency component and at least one high frequency component of the at least one audio signal;
processing 205 the at least one low frequency component to generate at least one harmonic component associated with the at least one low frequency component;
adjusting 207 at least one of the at least one harmonic component and the at least one high frequency component relative to each other; and
generating 209 an output signal based on the adjusted at least one harmonic component and at least one high frequency component to cause improved low frequency perception of the at least one audio signal during playback.

The computer program instructions can be comprised in a computer program 509, a non-transitory computer readable medium, a computer program product, a machine readable medium. In some but not necessarily all examples, the computer program instructions can be distributed over more than one computer program 509.

Although the memory 507 is illustrated as a single component/circuitry it can be implemented as one or more separate components/circuitry some or all of which can be integrated/removable and/or can provide permanent/semi-permanent/dynamic/cached storage.

Although the processor 505 is illustrated as a single component/circuitry it can be implemented as one or more separate components/circuitry some or all of which can be integrated/removable. The processor 505 can be a single core or multi-core processor.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term ‘circuitry’ may refer to one or more or all of the following:
(a) hardware-only circuitry implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory or memories that work together to cause an apparatus, such as a mobile phone or server, to perform various functions and
(c) hardware circuit(s) and or processor(s), such as a microprocessor(s) or a portion of a microprocessor(s), that requires software (for example, firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor and its (or their) accompanying software and/or firmware. The term circuitry also covers, for example and if applicable to the particular claim element, a baseband integrated circuit for a mobile device or a similar integrated circuit in a server, a cellular network device, or other computing or network device.

The blocks illustrated in FIG. 2 can represent steps in a method and/or sections of code in the computer program 509. The illustration of a particular order to the blocks does not necessarily imply that there is a required or preferred order for the blocks and the order and arrangement of the blocks can be varied. Furthermore, it can be possible for some blocks to be omitted.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this description, the wording ‘connect’, ‘couple’ and ‘communication’ and their derivatives mean operationally connected/coupled/in communication. It should be appreciated that any number or combination of intervening components can exist (including no intervening components), i.e., so as to provide direct or indirect connection/coupling/communication. Any such intervening components can include hardware and/or software components.

As used herein, the term “determine/determining” (and grammatical variants thereof) can include, not least: calculating, computing, processing, deriving, measuring, investigating, identifying, looking up (for example, looking up in a table, a database or another data structure), ascertaining and the like. Also, “determining” can include receiving (for example, receiving information), accessing (for example, accessing data in a memory), obtaining and the like. Also, “determine/determining” can include resolving, selecting, choosing, establishing, and the like.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

Although examples have been described in the preceding paragraphs with reference to various examples, it should be appreciated that modifications to the examples given can be made without departing from the scope of the claims.

Features described in the preceding description may be used in combinations other than the combinations explicitly described above.

Although functions have been described with reference to certain features, those functions may be performable by other features whether described or not.

Although features have been described with reference to certain examples, those features may also be present in other examples whether described or not.

The term ‘a’, ‘an’ or ‘the’ is used in this document with an inclusive not an exclusive meaning. That is any reference to X comprising a/an/the Y indicates that X may comprise only one Y or may comprise more than one Y unless the context clearly indicates the contrary. If it is intended to use ‘a’, ‘an’ or ‘the’ with an exclusive meaning then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

The above description describes some examples of the present disclosure however those of ordinary skill in the art will be aware of possible alternative structures and method features which offer equivalent functionality to the specific examples of such structures and features described herein above and which for the sake of brevity and clarity have been omitted from the above description. Nonetheless, the above description should be read as implicitly including reference to such alternative structures and method features which provide equivalent functionality unless such alternative structures or method features are explicitly excluded in the above description of the examples of the present disclosure.

Whilst endeavoring in the foregoing specification to draw attention to those features believed to be of importance it should be understood that the Applicant may seek protection via the claims in respect of any patentable feature or combination of features hereinbefore referred to and/or shown in the drawings whether or not emphasis has been placed thereon.

1. An apparatus, comprising:
at least one processor; and
at least one memory storing instructions that, when executed with the at least one processor, cause the apparatus at least to:
obtain at least one audio signal;
obtain at least one low frequency component and at least one high frequency component of the at least one audio signal;
process the at least one low frequency component to generate at least one harmonic component associated with the at least one low frequency component;
adjust at least one of the at least one harmonic component or the at least one high frequency component relative to each other; and
generate an output signal based on the adjusted at least one harmonic component or the at least one high frequency component to cause improved low frequency perception of the at least one audio signal during playback.

2. An apparatus as claimed in claim 1 wherein the instructions, when executed with the at least one processor, cause the apparatus to determine a synchrony value based, at least on, the at least one high frequency component or the generated at least one harmonic component and wherein the adjustment of at least one of the at least one harmonic component or the at least one high frequency component relative to each other controls synchrony between the at least one high frequency component or the at least one harmonic component.

3. An apparatus as claimed in claim 2 wherein the instructions, when executed with the at least one processor, cause the apparatus to determine a level of coherence between the at least one harmonic component associated with the at least one low frequency component or the at least one high frequency component for different delay adjustments between the two components.

4. An apparatus as claimed in claim 2, wherein the instructions, when executed with the at least one processor, cause the apparatus to determine synchrony values for different frequency bands and the adjustments are made separately for different frequency bands.

5. An apparatus as claimed in claim 2, wherein the instructions, when executed with the at least one processor, cause the apparatus to filter the at least one harmonic component associated before the synchrony value is determined.

6. An apparatus as claimed in claim 2, wherein the instructions, when executed with the at least one processor, further cause the apparatus to at least one of:
add a delay to the at least one high frequency component before the synchrony value is determined; or
adjust the delay added to the at least one high frequency component.

7. (canceled)

8. An apparatus as claimed in claim 1, wherein the instructions, when executed with the at least one processor, cause the apparatus to sum the at least one high frequency component and the adjusted at least one harmonic component to produce the output signal.

9. An apparatus as claimed in claim 1, wherein the instructions, when executed with the at least one processor, cause the apparatus to apply a nonlinear function to the at least one low frequency component.

10. An apparatus as claimed in claim 1, wherein the instructions, when executed with the at least one processor, cause the apparatus to adjust a phase of at least one of the at least one high frequency component or the at least one harmonic component.

11. An apparatus as claimed in claim 1, wherein the at least one audio signal comprises multiple channels.

12. An apparatus as claimed in claim 11, wherein the instructions, when executed with the at least one processor, cause the apparatus to obtain at least one of:
at least one low frequency component for a sum of two or more channels; or
at least one high frequency component for a subset of channels.

13. (canceled)

14. A method, comprising:
obtaining at least one audio signal;
obtaining at least one low frequency component and at least one high frequency component of the at least one audio signal;
processing the at least one low frequency component to generate at least one harmonic component associated with the at least one low frequency component;
adjusting at least one of the at least one harmonic component or the at least one high frequency component relative to each other; and
generating an output signal based on the adjusted at least one harmonic component or the at least one high frequency component to cause improved low frequency perception of the at least one audio signal during playback.

15. A non-transitory program storage device readable with an apparatus, tangibly embodying a program of instructions executable with the apparatus for performing at least:
obtaining at least one audio signal;
obtaining at least one low frequency component and at least one high frequency component of the at least one audio signal;
processing the at least one low frequency component to generate at least one harmonic component associated with the at least one low frequency component;
adjusting at least one of the at least one harmonic component or the at least one high frequency component relative to each other; and
generating an output signal based on the adjusted at least one harmonic component or the at least one high frequency component to cause improved low frequency perception of the at least one audio signal during playback.

16. A method as claimed in claim 12, further comprising determining a synchrony value based, at least on, the at least one high frequency component or the generated at least one harmonic component, and wherein the adjustment of at least one of the at least one harmonic component or the at least one high frequency component relative to each other controls synchrony between the at least one high frequency component or the at least one harmonic component.

17. A method as claimed in claim 12, wherein determining a synchrony value comprises at least one of:
determining a level of coherence between the at least one harmonic component associated with the at least one low frequency component or the at least one high frequency component for different delay adjustments between the two components; or
determining synchrony values for different frequency bands and the adjusting is made separately for different frequency bands.

18. A method as claimed in claim 12, further comprising filtering the at least one harmonic component associated before determining a synchrony value.

19. A method as claimed in claim 12, further comprising at least one of:
adding a delay to the at least one high frequency component before determining a synchrony value; or
adjusting the delay added to the at least one high frequency component.

20. A method as claimed in claim 12, wherein generating the output signal based on the adjusted at least one harmonic component and the at least one high frequency component comprises summing the at least one high frequency component and the adjusted at least one harmonic component to produce the output signal.

21. A method as claimed in claim 12, wherein processing of the at least one low frequency component to generate the at least one harmonic component comprises applying a nonlinear function to the at least one low frequency component.

22. A method as claimed in claim 12, wherein the adjustment comprises adjusting a phase of at least one of the at least one high frequency component or the at least one harmonic component.
